(19) United States
(12) Patent Application Publication
(10) Pub. No.: US 2013/0117159 A1
(43) Pub. Date: May 9, 2013

(54) TRANSACTION PLATFORM DATA PROCESSING METHOD AND SYSTEM

(71) Applicant: Alibaba Group Holding Limited, George Town (KY)

(72) Inventor: Weiye Chen, Hangzhou (CN)

(73) Assignee: ALIBABA GROUP HOLDING LIMITED, George Town (KY)

(21) Appl. No.: 13/669,214

(22) Filed: Nov. 5, 2012

(30) Foreign Application Priority Data
Nov. 7, 2011 (CN) 201110348703.X

(51) Int. Cl. G06Q 30/06

(52) U.S. Cl. 705/26.81

(57) ABSTRACT

Embodiments of the invention relate to a transaction platform data processing method, and a transaction platform data processing system. The transaction platform data processing method includes: receiving order information corresponding to an order transmitted by a transaction platform, the order information comprising order amount and seller information; retrieving credit information of a seller, the credit information being based on the seller information; determining, using one or more computer processors, whether the order conforms to credit conditions based on the credit information of the seller and the order information; and in the event that the order conforms to the credit conditions, performing credit processing for the order and recording the order in the credit database.

### CROSS REFERENCE TO OTHER APPLICATIONS

This application claims priority to People's Republic of China Patent Application No. 201110348703.X entitled TRANSACTION PLATFORM DATA PROCESSING METHOD AND SYSTEM filed Nov. 7, 2011 which is incorporated herein by reference for all purposes.

### FIELD OF THE INVENTION

This application relates to a transaction platform data processing method and system.

### BACKGROUND OF THE INVENTION

With the development of e-commerce, an increasing number of people are purchasing products using online shopping and paying for the products using an online payment method. The products purchased using the online shopping are also gradually evolving from small items of low cost towards larger items having a higher cost. Traditionally, in order to guarantee the interests of both buyers and sellers, many transaction platforms have been provided by third parties. After a buyer selects a product to be purchased, the buyer is required to deposit a payment into an account on the transaction platform. The transaction platform guarantees the transaction, and the third party transfers the deposited payment to the seller when the buyer has received the product from the seller. In other words, during the period after the seller ships the product and before the buyer receives the product, the seller cannot receive any payment. This period is particularly troublesome for the seller when the transaction volume is relatively large or unit prices of the product are relatively high. Accordingly, some transaction platforms offer sellers credit guarantee services. The credit guarantee services help alleviate funding pressure on the seller because the transaction platform offers a loan to the seller in the event that the seller presents an application to the transaction platform.

Credit guarantees are typically accomplished manually via a credit guarantee application process. In other words, after the seller submits a completed credit guarantee application, the transaction platform reviews the application, and a credit guarantee is issued based on the results of the review of the application. This application process undoubtedly increases processing time and makes the application process cumbersome. Additionally, for some sellers, the time required to obtain a credit guarantee is determined based on the time at which the transaction is completed. However, the seller needs the credit guarantee when a large number of transactions are generated, but does not need the credit guarantee when there are little or no transactions. Therefore, the credit guarantee application process may be unable to fulfill the seller's demand for timely and flexible funding. In particular, when the number of credit transactions and the complexity of credit conditions increase, for example, in examining whether a transaction conforms to the scope of credit when many product categories exist, the inability to manually process such credit guarantee applications promptly makes the process extremely burdensome to implement.

### BRIEF DESCRIPTION OF THE DRAWINGS

Various embodiments of the invention are disclosed in the following detailed description and the accompanying drawings.

FIG. 1A is a diagram illustrating an embodiment of a transaction platform data processing system;

FIG. 1B is a flowchart illustrating an embodiment of a transaction platform data processing method;

FIG. 2 is a flowchart illustrating another embodiment of the transaction platform data processing method;

FIG. 3 is a diagram illustrating an embodiment of a transaction platform data processing system; and

FIG. 4 is a diagram illustrating another embodiment of the transaction platform data processing system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In order that the above-stated objectives, features, and advantages of the present application may be more easily understood, the present application is explained in greater detail below in light of the attached drawings and specific embodiments.

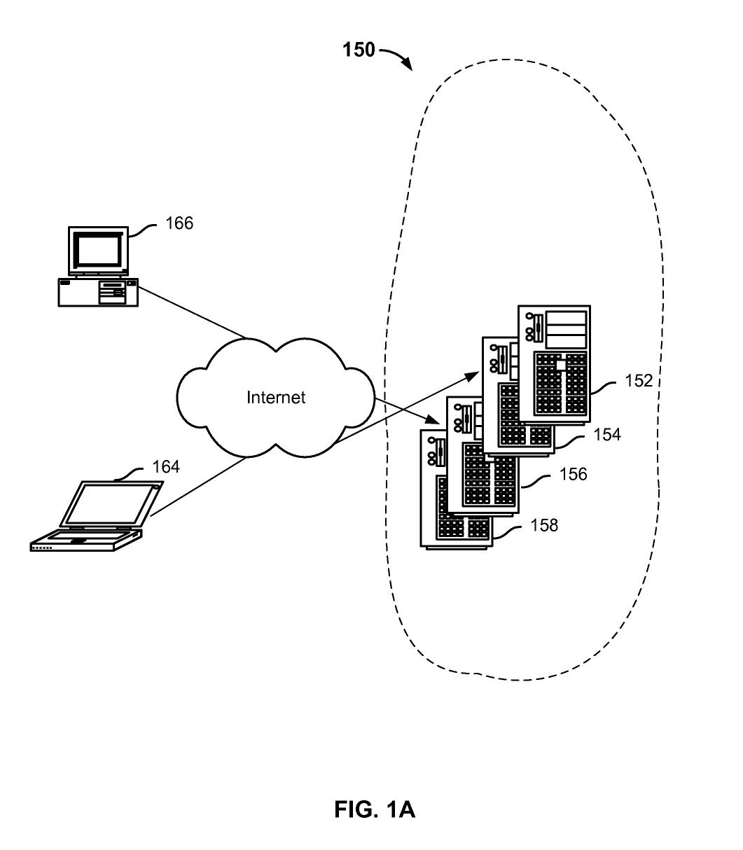

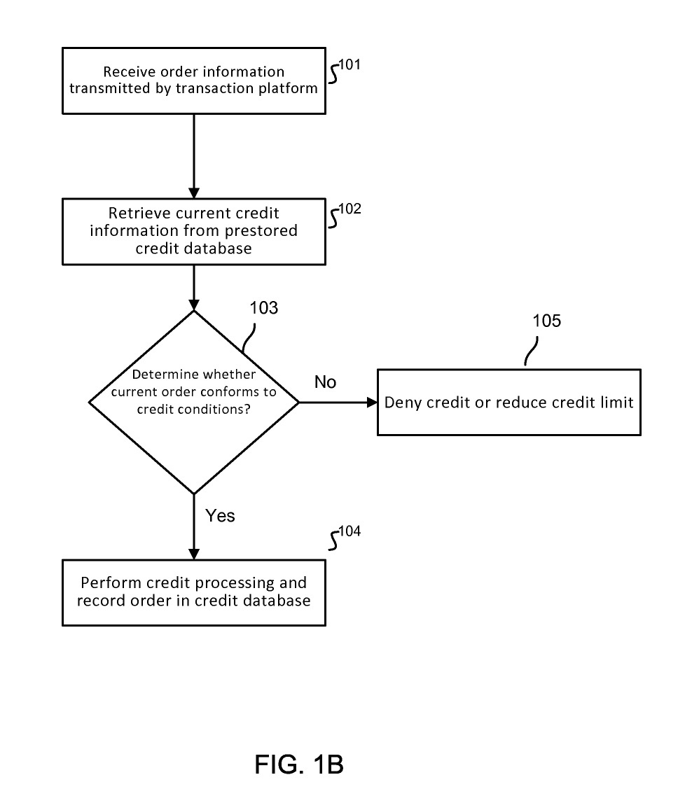

FIG. 1A is a diagram illustrating an embodiment of a transaction platform data processing system. In this example, system 150 includes a plurality of application servers 152, 154, 156, and 158. In some embodiments, the application servers 152, 154, 156, and 158 constitute a transaction platform. Although four application servers are used for purposes of example, different numbers of application servers may be used in other embodiments. URL resource access requests from clients such as 164 and 166 are received by the application servers. The clients and the application servers may communicate over TCP/IP or any other network protocol.

FIG. 1B is a flowchart illustrating an embodiment of a transaction platform data processing method. The method can be performed on the system 150. The transaction platform data processing method includes the following steps:

Step 101 includes receiving order information transmitted by a transaction platform. The order information may include order amount and seller information.

After a buyer has selected a product sold by a seller and generated an order, payment of the order may be processed by the transaction platform. The transaction platform receives the payment from the buyer and records order information related to the order. The payment comes from the buyer's line of credit, buyer's bank account, or the like. The recorded order information may include product information, seller information, buyer information, payment information and the order amount. Upon confirmation that the buyer has paid the order amount into the transaction platform, the transaction platform transmits the order information to the transaction platform.

Step 102 includes retrieving or locating credit information of the seller from a prestored credit database based on the seller information.

The credit information of the seller may include credit limit. The credit limit may also be known as the credit amount available. The transaction platform may set the credit limit for the seller in advance and store the credit limit for the seller in the credit database. The credit limit may be determined based on information relating to category of products sold by the seller and creditworthiness of the seller. In one example, determining the credit limit may include the following process:

The transaction platform retrieves the seller information. In some embodiments, the seller information includes security deposit paid by the seller to the transaction platform, category of products sold by the seller, and creditworthiness of the seller. The transaction platform determines the credit limit for the seller based on the seller information.

The credit limit of the seller may be stored in the credit database on the transaction platform. After the transaction platform retrieves the order amount and the seller information corresponding to the received order information, the transaction platform locates the credit limit of the seller based on the seller information retrieved. In one example, the credit limit corresponds to an amount of the same magnitude as the actual amount. For example, a credit limit of 100 is equivalent to $100. In another example, the credit limit corresponds to a percentage of an amount after processing. For example, a credit limit of 100 is equivalent to $10 and the like.

By determining the credit limit, transactions may be handled more efficiently, transaction platform data may be processed quicker, and transaction risk may be reduced.

Step 103 includes determining whether the current order conforms to credit conditions based on the current credit information of the seller and the current order information.

Step 104, in the event that the current order conforms to the credit conditions, credit processing is performed on the current order, and the current order is recorded in the credit database.

In some embodiments, the current order is determined to conform in response satisfying the following credit conditions: an acceptable credit limit, a likelihood that the seller will default falls below a predetermined threshold, the product price in the current order falling within a normal range, and an amount of the current order is below the credit limit of the seller. In the event that credit is extended, the corresponding credit processing may proceed using one or any combination of the above credit conditions. The credit processing may include the following steps:

The credit processing may compare the current credit and the order amount. In the event that the credit limit is greater than the order amount, the transaction platform pays the seller an amount corresponding to the order amount. Subsequently, the credit processing for this transaction is terminated.

In the event that the transaction platform pays the amount corresponding to the order amount to the seller, the transaction platform no longer needs to wait for confirmation that the shipment has been received by the buyer before performing the credit processing. Thus, the speed of processing of the transaction is accelerated, and funds are allowed to be delivered to the seller quicker alleviating funding pressure of the seller. In the event that the shipment has not been received by the buyer within a predetermined time, the transaction platform verifies the order, reimburses the buyer the amount paid, and rescinds the amount given to the seller for the order.

In some embodiments, the amount paid corresponding to the order amount is equivalent to the order amount. For example, as long as the credit limit is greater than the order amount, the current order may be paid in full to the seller. In some embodiments, the amount paid corresponding to the order amount is a portion of the order amount where the portion of the order amount is less than 100% of the order amount. For example, the portion of the order amount may be 50%, 80%, or any percentage less than 100%. The percent of the order amount can be fixed. For example, the portion of the order amount can be a fixed percentage for every seller. In another example, the portion of the order amount can be determined based on historical transaction data of the seller stored in the credit database of the transaction platform or historical transaction data for the ordered product in the transaction platform. The historical transaction data for the ordered product in the transaction platform may be determined using a predetermined computation rule to compute a numerical value that expresses creditworthiness of the seller, and the percentage corresponding to a portion of the order amount may be determined based on the computed numerical value. For example, in the event that the computed numerical value corresponding to the creditworthiness of a particular seller is 60%, the portion of the order amount may be 60% or another percentage relating to the portion of the order amount. The portion of the order amount may be determined based on other predetermined rules. The predetermined rules are not limited by the present application.

In order to reduce the likelihood of default of the seller, after the transaction platform receives order information and before the transaction platform pays the amount corresponding to the order amount to the seller, the credit processing further includes the following steps in some embodiments:

In some embodiments, the product information related to the order includes the historical transaction data for the product, the historical transaction data of the seller, or a combination thereof. The product information related to the order may be stored in the transaction platform.

The average transaction price of product can be determined from the historical transaction data of the product, and a determination is made whether the difference between the order amount of the product and the average transaction price for the product falls within a predetermined range. In the event that the difference between the order amount and the average transaction price for the product is within a predetermined range, payment of the amount corresponding to the order amount to the seller may be permitted.

In some embodiments, the likelihood of default of the seller is determined based on the historical transaction data of the seller. In the event that the likelihood that the seller will default is less than a threshold value, the payment of the amount corresponding to the order amount to the seller may be permitted.

Thus, the credit processing may include the determination of whether the difference between the order amount and the average transaction price for the product falls within a predetermined range, the determination of the likelihood that the seller will default based on the historical transaction data of the seller, or any combination thereof

The above determination of whether the difference between the order amount and the average transaction price for the product falls within the predetermined range may be determined using data collected in advance. For example, average prices for products of various categories may be determined in advance. A comparison of the order amount against the average transaction price for products of the corresponding category may be made. In the event that the difference between the order amount and the average transaction price for products of the corresponding category falls within the permitted range, payment to the seller of the amount corresponding to the order amount may be permitted. In another example, the recent historical transaction data of the seller within a predetermined time period is retrieved in advance. In various embodiments historical transaction data of the seller includes product reviews, shipping times, delivery times, and the like. In the event that the historical transaction data of the seller is normal, the historical transaction data of the seller may indicate that the likelihood of default of the seller is relatively low. Subsequently, the payment of an amount corresponding to the order amount to the seller may be permitted. Based on the computation rule, a numerical value corresponding to a likelihood of default of the seller based on the historical transaction data may be computed, and the numerical value may be stored in the credit information of the seller, so that the numerical value corresponding to a likelihood of default of the seller may be retrieved when requested.

Because a large number of sellers may exist in the transaction platform, in order to reduce the volume of data processed, in some embodiments, a credit limit for each seller is adjusted at a predetermined interval. Moreover, during the credit processing, the creditworthiness and the product categories sold by some sellers can change after the time that the credit limit was established. Using real-time analysis of order information to determine whether credit processing may be performed can reduce the likelihood of default of the seller. Additionally, because the volume of orders generated each day may be very large for a transaction platform, manual processing of each credit order would likely increase workload and manpower costs. Accordingly, implementing automated credit procession using the transaction platform reduces or eliminates manual processing, reduces credit processing time, and reduces workload and manpower costs.

Furthermore, the order information can include product information, the credit conditions can include an authorized category of products, and a determination can be made whether the product information contained in the order information conforms to a scope of the authorized category of products. In the event that the product information contained in the order information conforms to the scope of the authorized credit products, credit processing is performed. Step 105, in the event that the product information contained in the order information does not conform to the scope of the authorized category of products, credit may be denied or the credit limit may be reduced. In this example, a determination whether the scope of the category of products sold by the seller conforms to the scope of the authorized category of products is made. For example, assume that computer products are an authorized category of products. A determination is made as to whether the product sold falls within the category of computer products. If the product is determined to be a computer product, the product conforms to the scope of the authorized category of products. Otherwise, the product does not conform to the scope of the authorized category of products. In the event that the scope of the category of products sold by the seller conforms to the scope of the authorized category of products, the credit processing may be performed.

In some embodiments, in order to ensure the accuracy of the data processing method, concurrent with payment to the seller of the amount corresponding to the order amount, the amount corresponding to the order amount is deducted from the credit limit of the seller. After the buyer has confirmed that the shipment has been received or the order is complete, the seller information contained in the order and the current credit information of the seller are retrieved. Based on the credit information of the seller, the amount deducted from the credit limit of the seller during the credit processing is returned to the seller. In other words, the credit limit that the seller had before the order is restored. For sellers having a portion of the merchandise returned during the credit processing, at this time, based on a difference between the actual total merchandise amount returned to the seller recorded in the credit database and the actual order amount contained in the order information, it is possible to pay the remaining balance to the seller, thus completing the transaction. In other words, the remaining balance can be the difference between the actual total merchandise amount returned to the seller and the actual order amount contained in the order information.

The amount deducted from the credit limit may correspond to the full order amount or a predetermined percentage of the order amount. The predetermined percentage can be determined based on actual need. For example, the predetermined percentage may be 10 to 1. For example, for every 10 dollars of the order amount, 1 dollar of the credit limit is deducted, etc. The determination of the predetermined percentage is not limited by the present application.

In the event that the deducted credit limit is returned to the seller, an identifier may be associated with each returned credit limit, or return details may be recorded indicating that the deducted credit limit for the transaction has been returned. The identifier or the recordation is used to avoid duplication of the returns to the credit limit ensuring the accuracy of the data processing method.

During the transaction platform data processing method, multiple transactions may occur substantially simultaneously. For example, multiple groups of transaction data associated with the multiple transactions may need to be processed substantially simultaneously. In order to ensure the accuracy of the data processing method, the data processing method may be implemented using a method of processing of one group of transactions completely before processing the next group of transactions. In another example, in order to more efficiently implement the data processing method, multiple groups of transactions may be processed substantially simultaneously. For example, for two order amounts that are each less than the credit limit, the two order amounts are compared to the credit limit individually. However, after one order amount is deducted from the credit limit, the remaining credit amount may be less than the remaining order amount. Thus, in order to ensure the accuracy of the data processing method, upon each deduction from the credit limit, a comparison of the current credit limit and the order amounts of the orders to be processed is performed to ensure that the credit limit is greater than the current order amount in order to avoid a negative credit limit. For example, assume that the credit limit for a buyer is $1000. If the seller receives one order for $800 and another order for $500 from the same buyer. After processing the first order of $800, the credit limit is not sufficient for the second order because the remaining credit limit of $200 will not cover the $500 order.

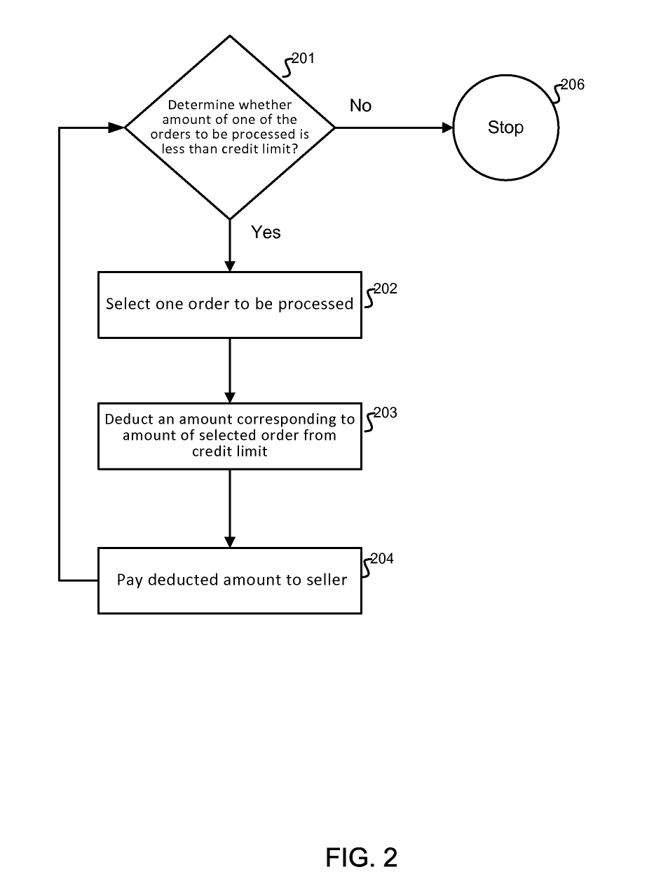

Referring to FIG. 2, FIG. 2 illustrates another embodiment of the transaction platform processing method. The method including the following steps:

Step 201 includes comparing the credit limit and the order amount of each order to be processed, and determining whether one of the order amounts is less than the credit limit. In the event that one of the order amounts is less than the credit limit, step 202 is accessed. In the event that none of the order amounts is less than the credit limit, step 206 is accessed. At 206, the process is terminated.

Step 202 includes selecting one of the order amounts less than the credit limit.

Step 203 includes deducting an amount corresponding to the selected order amount from the credit limit.

Step 204 includes paying the amount corresponding to the selected order amount to the seller, and returning back to step 201.

In one example, the sequence in which orders are processed may correspond with the sequence in which order amounts are paid by the transaction platform.

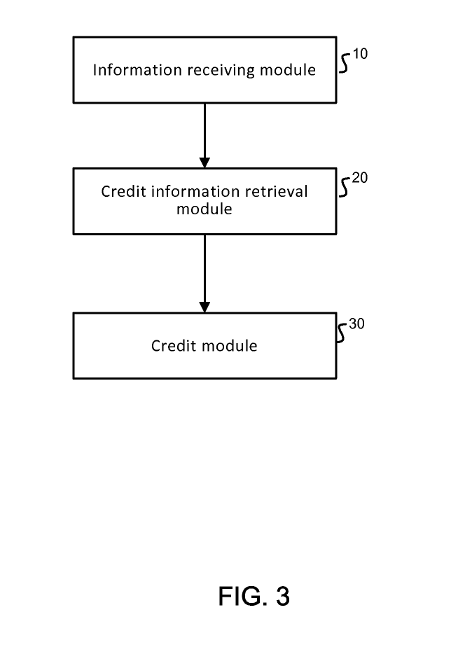

FIG. 3 illustrates an embodiment of a transaction platform data processing system in the present application. The transaction platform data processing system includes an information receiving module 10, a credit limit retrieval module 20, and a comparison module 30.

The information receiving module 10 receives the order information transmitted by the transaction platform, the order information including the order amount and the seller information.

The credit information retrieval module 20 retrieves the current credit information of the seller from a prestored credit database based on the seller information. The current credit information of the seller may be retrieved after retrieving the seller information. The credit information of the seller may include the credit limit of the seller, the creditworthiness of the seller, transaction data of the seller, and the like.

The credit module 30 determines whether the current order conforms to credit conditions based on the current credit information of the seller and the current order information. In the event that the order conforms to the credit conditions, credit processing is performed for the current order and the current order is recorded in the credit database.

In one example, the system may further include a credit limit determination module configured to determine the credit limit of the seller. Factors used in determining the credit limit of the seller include the security deposit paid by the seller, the category of products sold by the seller, and the creditworthiness of the seller.

In another example, the system may further include a credit amount deduction module configured to deduct a credit amount from the credit limit of the seller simultaneously upon payment of the order amount to the seller. The credit amount corresponds to an amount corresponding to the full order amount or a predetermined percentage of the order amount.

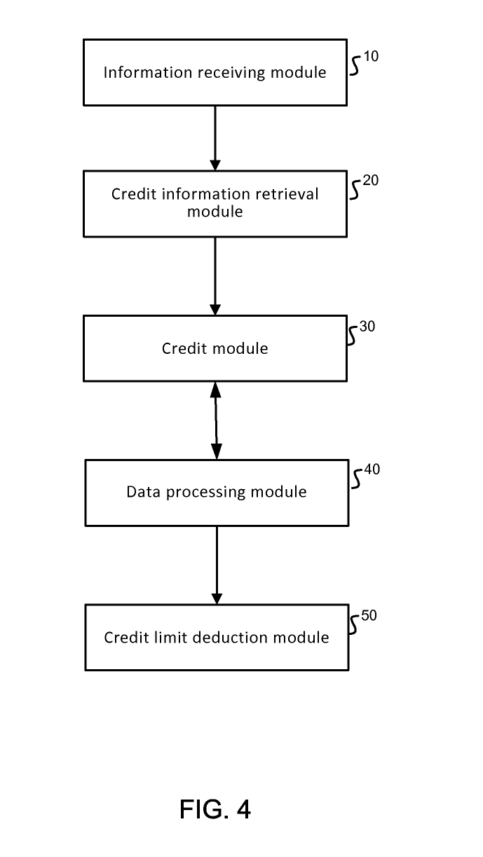

Referring to FIG. 4, FIG. 4 illustrates another embodiment of the transaction platform data processing system. In comparison to the embodiment illustrates in FIG. 3, the system illustrated in FIG. 4 further includes a data processing module 40 and a credit limit deduction module 50. The data processing module 40 performs credit processing based on the determination of the credit module 30. The credit limit of the seller may be retrieved by the credit information retrieval module 20, and the order amount may be retrieved by the information receiving module 10. The credit processing may include comparing the credit limit with the order amount of each order to be processed, and determining whether one of the order amounts is less than the credit limit. In the event that none of the order amounts is less than the credit limit, processing is terminated. In the event that one of the order amounts is less than the credit limit, the one order amount less than the credit limit is selected. The credit limit deduction module 50 deducts an amount corresponding to the one order amount from the credit limit of the seller, and the amount corresponding to the order amount is paid to this seller. The processing is repeated until processing of all of the orders is complete or the credit limit is less than the order amount of each of the remaining orders and is insufficient to be extended for any of the remaining orders.

In another example, the system may further include a credit limit return module configured to return the deducted credit amount to the credit limit of the seller.

This credit limit return module may include an identifier addition module or a recording module. The identifier addition module may add an identifier to each credit limit returned. The recording module may record details of each credit limit return.

In another example, an implementation of data processing during a transaction by the transaction platform data processing method and system in light of the above embodiments is described below. The transaction platform may include three parts: a background management database (CMR, customer-managed relationship), a transaction center (TC) and a transaction payment platform.

First, the background management database determines an initial credit limit for the seller. The credit limit may be determined based on factors including the security deposit paid by the seller to the transaction platform, the creditworthiness of the seller and the category of products sold by the seller. After a buyer has selected a certain product of the seller and has paid a payment amount via the transaction payment platform, the transaction payment platform transmits the payment information and the corresponding seller information to the transaction center. Based on the seller information retrieved, the transaction center retrieves the credit limit of the seller from the background management database, and compares the credit limit with the acquired payment amount. In the event that the credit limit is greater than the payment amount, the transaction center processes the current order as a credit order. For example, the transaction center notifies the background management database to deduct an amount equivalent to the payment amount from the credit limit of the seller, and simultaneously notifies the transaction payment platform to pay the deducted amount to the seller.

Furthermore, in the event that the credit order is complete, i.e., the transaction center has received confirmation from the buyer confirming receipt of the ordered product, the transaction center returns the credit limit deducted for the transaction to the seller.

In the event that the credit limit is less than the payment amount, the transaction center processes the current order as a non-credit order, i.e., notifies the transaction payment platform to temporarily withhold payment to the seller and pays the seller after the buyer confirms receipt of the ordered product. Thus, the accuracy of the credit limit is ensured.

The modules described above can be implemented as software components executing on one or more processors, as hardware such as programmable logic devices and/or Application Specific Integrated Circuits designed to perform certain functions or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices. The functions of the modules may be merged into one another or further split into multiple sub-modules.

The transaction platform data processing method and system reduces transaction risk by setting credit limits. Thus, the method and the system enable prompt processing of transaction data without a backlog of system operation resulting from waiting for transactions to be complete before processing. Concurrently, the method and the system ensure the accuracy of the data processing.

Also, the method of deducting the credit limit reduces transaction risk. In the event that the credit limit is deducted for multiple transactions proceeding simultaneously, the method deducts the credit limit one by one and performs a new comparison before each deduction occurs ensuring the accuracy of the credit limit.

Additionally, for transactions in which the values of the products are relatively high, such as airline tickets, furniture, homes, and real estate, the method enables payment of funds to the seller quickly alleviating funding pressure on the seller.

Each of the embodiments contained in this specification is described in a progressive manner, the explanation of each embodiment focuses on areas of difference from the other embodiments, and the descriptions thereof may be mutually referenced for portions of each embodiment that are identical or similar. In regard to the system embodiments, because they are fundamentally similar to the method embodiments, the descriptions are relatively simple; portions of the explanation of the method embodiments can be referred to for the relevant aspects.

The transaction platform data processing method and system offered by the present application have been described in detail above. This document has employed specific embodiments to expound the principles and forms of implementation of the present application. The above embodiment explanations are only meant to aid in comprehension of the methods of the present application and of its core concepts. Moreover, a person with general skill in the art would, on the basis of the concepts of the present application, be able to make modifications to specific applications and to the scope of applications. To summarize the above, the contents of this description should not be understood as limiting the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A transaction platform data processing method, the method comprising:
receiving order information corresponding to an order transmitted by a transaction platform, the order information comprising order amount and seller information;
retrieving credit information of a seller, the credit information being based on the seller information;
determining, using one or more computer processors, whether the order conforms to credit conditions based on the credit information of the seller and the order information; and
in the event that the order conforms to the credit conditions, performing credit processing for the order and recording the order in the credit database.

2. A transaction platform data processing method as described in claim 1, wherein the credit processing comprises:
comparing a credit limit of the seller and an order amount of the order; and
in the event that the credit limit of the seller is greater than the order amount, paying the seller an amount corresponding to the order amount prior to a buyer verifying that a shipment of the order has been received.

3. A transaction platform data processing method as described in claim 2, wherein the determining comprises:
computing creditworthiness of the seller based on historical transaction data of the seller, historical transaction data for a product in the order, or any combination thereof; and
determining a percentage of the amount to be paid to the seller based on the computed creditworthiness of the seller.

4. A transaction platform data processing method as described in claim 2, wherein the determining operation comprises:
determining an average transaction price for a product in the order based on historical transaction data for the product; and
determining whether a difference between the order amount and the average transaction price for the product is within a first threshold value, wherein in the event that the difference between the order amount and the average transaction price for the product is within the first threshold value, permitting a payment of the amount corresponding to the order amount to the seller; or
determining a likelihood of default by the seller based on the transaction data of the seller, wherein in the event that the likelihood of default by the seller is less than a second threshold value, permitting a payment of the amount corresponding to the order amount to the seller.

5. A transaction platform data processing method as described in claim 2, wherein:
the order information comprises product information of a product in the order; and
the determining operation comprises:
determining whether the product information included in the order information conforms to the credit conditions;
in the event that the product information conforms to the credit conditions, performing credit processing; and
in the event that the product information does not conform to the credit conditions, denying credit to the seller or reducing the credit limit of the seller.

6. A transaction platform data processing method as described in claim 2 wherein:
the amount corresponding to the order amount comprises a full amount or a predetermined percentage of the order amount.

7. A transaction platform data processing method as described in claim 6 further comprises simultaneously processing a plurality of orders, the simultaneously processing of the plurality of orders comprising:
comparing the credit limit and order amounts of the orders to be processed;
determining whether an amount of one of the order amounts is less than the credit limit;
in the event that one of the order amounts is less than the credit limit,
selecting the order corresponding to the one order amount being less than the credit limit,
deducting an amount corresponding to the selected order from the credit limit, and
paying the deducting amount to the seller.

8. A transaction platform data processing method as described in claim 7 further comprises:
in the event that a confirmation has been receive that a buyer has received the order or completed the order, retrieving the seller information for the current order and the credit information of the seller from the credit database;
returning the credit limit deducted during the credit processing of the order to the seller; and
in the event that the paying of the seller is the predetermined percentage of the order amount, paying the remaining percentage to the seller.

9. A transaction platform data processing method as described in claim 8 further comprises:
adding an identifier to each credit limit returned or recording the details of the returning.

10. A transaction platform data processing method as described in claim 1 further comprises determining the credit limit of the seller based on the seller information, the seller information comprising security deposit paid by the seller, category of the products sold, and creditworthiness of the seller.

11. A transaction platform data processing method as described in claim 1, wherein the retrieving of the credit information of the seller is from a prestored credit database.

12. A transaction platform data processing method as described in claim 1, wherein in the event that a shipment has not been received by a buyer, verifying the order, refunding the order amount to the buyer and rescinding the order amount credited to the seller.

13. A transaction platform data processing system, the system comprising:
a plurality of application servers comprising:
an information receiving module configured to receive order information corresponding to an order transmitted by a transaction platform, the order information comprising order amount and seller information;
a credit information retrieval module configured to retrieve credit information of the seller based on the seller information;
a credit module configured to determine whether the current order conforms to credit conditions based on the credit information of the seller and the current order information,
wherein in the event that the current order conforms to the credit conditions, the credit module performs credit processing for the current order and records the order in the credit database.

14. A transaction platform data processing system as described in claim 13 further comprises a credit limit determination module configured to determine a credit limit for the seller based on the seller information, the seller information comprising security deposit paid by the seller, category of products sold by the seller, creditworthiness of the seller, or any combination thereof.

15. A transaction platform data processing system, as described in claim 13, further comprises a credit limit deduction module configured to simultaneously pay an amount corresponding to the order to the seller and deduct the amount corresponding to the order from a credit limit of the seller, the amount corresponding to the order includes an amount corresponding to the full order or an amount corresponding to a predetermined percentage of the order.

16. A transaction platform data processing system as described in claim 14 further comprises a data processing module configured to perform credit processing based on the determination of the credit module, the current credit limit of the seller from the credit limit determination module, and the order amount retrieved by the information receiving module.

17. A transaction platform data processing system as described in claim 16, wherein the credit processing comprising:
comparing the credit limit of the seller and order amounts of the orders to be processed;
determining whether one of the order amounts is less than the credit limit;
in the event that one of the order amounts is less than the credit limit, selecting the order corresponding to the one order amount;
deducting of an amount corresponding to the selected order amount from the credit limit; and
paying the amount corresponding to the selected order amount to the seller.

18. A transaction platform data processing system, as described in claim 13, wherein the retrieving of the credit information of the seller is from a prestored credit database.

19. A transaction platform data processing system, as described in claim 13, wherein in the event that a shipment has not been received by a buyer, the credit module verifies the order, refunds the order amount to the buyer and rescinds the order amount credited to the seller.
